(19) United States
(12) Patent Application Publication
(10) Pub. No.: US 2010/0126940 A1
(43) Pub. Date: May 27, 2010

(54) UNDERWATER PLASMA PROCESSING APPARATUS AND SYSTEM AND METHOD FOR PROCESSING BALLAST WATER OF SHIP USING THE SAME

(76) Inventors: Han-Seong Ryu, Gyeongsangnam-do (KR); Yeon-Chul Ha, Gyeongsangnam-do (KR); Dong-Hyeok Seo, Gyeongsangnam-do (KR); Dong-Eun Kim, Gyeongsangnam-do (KR)

Correspondence Address: IP & T Law Firm PLC, 7700 Little River Turnpike, Suite 207, Annandale, VA, 22003, US

(21) Appl. No.: 12/595,725

(22) PCT Filed: Apr. 10, 2008
(86) PCT No.: PCT/KR08/02010

§ 371 Date: Oct. 13, 2009

(30) Foreign Application Priority Data
Apr. 10, 2007 (KR) 10-2007-0035299

(51) Int. Cl. C02F 1/30

(52) U.S. Cl. 210/744; 210/150; 210/86; 210/85

(57) ABSTRACT

There is provided an underwater pulse plasma processing apparatus including: a power supply unit for generating pulse power; at least one discharge unit for discharging the pulse power generated in the power supply unit to a water surface including an air layer or to water including air bubbles; and a plasma processing unit for removing underwater microorganisms through plasma generated by the at least one discharge device.

### TECHNICAL FIELD

The present invention relates to an underwater pulse plasma processing apparatus and a system and a method for processing ballast water of a ship using the same; and more particularly, to an underwater plasma processing apparatus which can remove various kinds of microorganisms in the ballast water of the ship by using the pulse power capable of instantly reaching high power by emitting large energy in a very short time and completely extinct bacteria by destructing cell membranes of the bacteria and a system and a method for processing ballast water of a ship using the same.

### BACKGROUND ART

Since invasion of NIS(Non-Indigenous Species) into the Great Lakes of Canada was reported in 1988, damages due to the NIS have occurred in various countries. It is known that the NIS have been transferred and introduced mainly through a ship and more particularly, the introduction of the NIS by the ballast water of the ship becomes more intensified.

The ballast water of the ship is a weight loaded to adjust a draught and a trim of the ship. The ballast water of the ship performs a function of maintaining a balance of the ship and improving the stability of the ship, and an assistance function of allowing a propeller and a rudder to be effectively operated in water in case where freight is not sufficiently loaded.

It is known that a coal carrier which plied between London and Tyne in the middle of 1840s was a ship firstly using the ballast water. In those days, dry ballast such as a rock, sand, or metal was used and the ballast water began to be used so as to save labor cost consumed to load and unload the freight.

In these days, sea water or fresh water is generally used as the ballast water since the sea water or the fresh water is easy to obtain and is advantageous to cost saving. However, in particular, ocean species which entered altogether at the time of putting the sea water are discharged from a port of shipment. Therefore, they are introduced to the other area. The IMO (International Maritime Organization) discloses that sea water of 10 billion tons is yearly transferred by the ship and organisms of 7-thousand species or more are transferred with the ballast water. Specialists assume that 3-thousand ocean species or more are transferred through the ballast water only in a day.

That is, when cargo ships or oilers which come from foreign countries unload imported minerals or oil, the centers of gravity of the ships around the surface of the water go up. At this time, when a part of the propeller is exposed on the surface of the water, the propeller runs idle in the air and thus the ship does not advance forward. Since the ship becomes lighter, a risk that the ship will be capsized becomes greater and greater. Therefore, the ship is a bit sank by filling the sea water in an inside of a bottom of an empty ship prior to departure. In this way, water filled to adjust a balance of the ship is the ‘ballast water’. Generally, the ballast water of 50,000 to 70,000 tons is filled in a 200,000-ton class oiler and the ballast water of 30,000 to 40,000 tons is filled in a 120,000-ton class cargo ship. At this time, ocean organisms are introduced with the sea water filling a tank. Therefore, the ships discharge the ballast water to the sea of a destination. The ocean organisms of the oiler or cargo ship's own country which are loaded in the ballast water are transferred to other countries, while an export cargo ship brings other countries' ocean organisms to the sea of the export cargo ship's country by loading the other countries' organisms on the ballast water.

Accordingly, the sea has been devastated by the foreign species introduced through the ballast water.

For example, a habitat and food (plankton) of a foreign species such as barnacle are the same as those of a native species such as sacculosiphonaria japonica. However, since the foreign species is more prolific and survives even under a contaminated environment, the foreign species is more advantages in competition. Accordingly, the foreign barnacle settled at home may expel the native barnacle in the end. Also, a long time ago, a native seal mussel abandoned a table to a Mediterranean seal mussel. That is, sea mussels we have are produced not in Korea but in Europe. Ciona intestinalis and styela plicata which did not live in Korea are extending their own habitats. As described above, it is supposed that the foreign species were load on the ballast water.

Meanwhile, Korean organisms were also transferred to the other countries being loaded on the ballast water. Korean king crabs transferred to Germany and U.S.A. 10 years ago rashly dig up rice fields and causes critical damage to rice culture. Gyehwa Island's shellfishes which were transferred to U.S.A. ate up phytoplankton while rapidly propagating. Therefore, other organisms starve to death.

A possibility that the organisms transferred by being loaded on the ballast water will adapt themselves to new circumstances is very low, for example, approximately 3%. However, organisms less sensitive to an environmental change, which endure salt or a temperature change or live in both the sea water and the fresh water mainly survive and since the survived foreign species are strange food to native predators, the survived foreign species are not well eaten by the native predators. Therefore, the foreign species uncontrollably propagate.

As described above, a measure for protecting the sea slowly devastated due to the invasion of the foreign species introduced through the ballast water is urgent.

According to a tendency that recently constructed ships are enlarged and have a high speed, more organisms are discharged to other ocean environments through the ballast water in very short time.

For this reason, a system of processing ballast water of the ship using various methods has been developed.

For example, a ship with the ballast water kills organisms in the ballast water by spraying chemicals to the ballast water or exposing the ballast water to ultraviolet rays during navigation so as to reduce damages caused due to the transfer of the foreign species. However, there is a disadvantage that the sea of the destination is contaminated when the ballast water mixed with the chemicals is discharged and the ultraviolet rays slowly extinct the organisms in the ballast water.

As a concrete example, a method using ozone is suggested in “DEVICE OF PURYFYING WATER BY OZONE” disclosed in the Korean Application No. 10-0098846-0000. However, in the method using the ozone, the ozone does not remain and thus a possibility of secondary contamination is high, processing cost is high, large-scale processing is difficult, and a ballast tank may be corroded due to the ozone.

A method of reducing the number of microorganisms and the number of anaerobic microorganisms is suggested in “METHOD AND APPARATUS FOR KILLING MICROORGANISMS IN SHIP BALLAST WATER” disclosed in the Korean Application No. 10-0350409-0000. However, in oxygenation and deoxygenation methods, the microorganisms are difficult to be completely killed and there are many difficulties in providing an oxygen supplying device and a deoxygenation device.

A method of reducing dissolved oxygen by using oxygen stripping gas is suggested in “APPARATUS AND METHOD FOR WATER TREATMENT” disclosed in the Korean Publication No. 10-2005-0020957. However, in the method using the oxygen stripping gas, the microorganisms are difficult to be completely killed.

A method using heat treatment is suggested in “COMBINED PROCESSING STRUCTURE OF WASTE GAS AND BALLAST WATER AND METHOD OF PROCESSING BALLAST WATER” disclosed in the Korean Publication No. 10-2003-0004129, but in the heat treatment method, there is a problem that a temperature elevates.

A method of treating ballast water chlorine dioxide serving as an antibacterial agent is suggested in “METHOD AND APPARATUS FOR CONTROLLING ORGANISMS IN BALLAST WATER” disclosed in the Korean Application No. 10-0654105-0000, but in a chemical treatment method, a possibility of secondary contamination is high and chemicals should be always loaded on the ship.

A method of sterilizing the ballast water by sterilization using sodium hypochloritein (others, solid chlorine, liquid chlorine, chlorine dioxide, etc.) serving as the antibacterial agent or ultraviolet rays sterilization, ozone sterilization, photocatalyst sterilization, and the like “APPARATUS FOR PURIFYING BALLAST WATER AND SHIP MOUNTED THE SAME” disclosed in the Korean Application No. 10-0743946-0000. However, in the chemical treatment method, the removal of the microorganisms is limitary, while in the method using ultraviolet rays, it is effective to only a part of the microorganisms and since wavelengths of the ultraviolet rays are short, the ultraviolet rays are difficult to show their own functions in turbid ballast water.

A method of treating the ballast water by using the ozone is suggested in “OZONE INJECTION METHOD AND SYSTEM” disclosed in the Korean Application No. 10-0812486-0000, but as described above, in the method using the ozone, the ozone does not remain and thus the possibility of the secondary contamination is high, the processing cost is high, the large-scale processing is difficult, and the ballast tank may be corroded due to the ozone.

A method of performing efficient sterilization with the ultraviolet rays or chemicals in a pretreatment process and reducing the survival of the microorganisms in disposal water by a coagulation filtering treatment is suggested in “FILTRATION AND PURIFICATION APPARATUS” disclosed in the Korean Application No. 10-0689135-0000. However, in the filtering method, the removal of the microorganisms is limitary, while in the method using ultraviolet rays, it is effective to only a part of the microorganisms and since wavelengths of the ultraviolet rays are short, the ultraviolet rays are difficult to show their own functions in turbid ballast water.

Meanwhile, a method of purifying waste water by using plasma is suggested in “APPARATUS FOR PURIFYING CONTAMINATED WATER” disclosed in the Korean Application No. 10-0304460-0000 and “THE STUDY OF CHARACTERISTICS ON WATER TREATMENT USING HYBRID WATER PLASMA TORCH (Journal of KIIEE, Vol. 20, No. 1, pp 138-143, January 2006)”. However, these prior arts are limited to the purification of the fresh water (the purification of the waste water) and show limitation in purifying the sea water. In particular, these arts show the limitations in removing various kinds of microorganisms (killing the ocean microorganisms) in the ballast water (sea water) of the ship by using the plasma. That is, the above-mentioned prior arts have a plasma treatment structure suitable for fresh water characteristics (a structure in which the plasma is generated and continuously circulated in waste water introduced through an inlet in the tank). However, by such structure, there is a limitation in sterilizing zooplankton, plan plankton, bacteria, and the like in the ballast water of the ship, which are discharged to the outside (the sea) on a large scale. In addition, even in the fresh water, the purification of contaminated water, the removal of a heavy metal, and the like are focused, while there is a limit in completely killing various kinds of microorganisms in the fresh water.

### DISCLOSURE

### Technical Problem

Accordingly, an embodiment of the present invention is directed to providing an underwater plasma processing apparatus which can remove various kinds of microorganisms in the ballast water of the ship by using pulse power capable of instantly reaching high power by emitting large energy in a very short time and completely extinct bacteria by destructing cell membranes of the bacteria, and a system and a method for processing ballast water of a ship using the same.

That is, the present invention has a technical object to remove the various microorganisms in the ballast water of the ship by performing both a treatment using physical factors (ultraviolet rays, shock waves, heat, and the like) and a treatment using chemical factors (ozone, hydrogen peroxide, OH-activating radicals) with the pulse power capable of instantly reaching the high power by emitting the large energy in the very short time and completely extinct the bacteria by destructing the cell membranes of the bacteria.

The objects of the present invention are not limited to the above-mentioned objects. Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided an underwater pulse plasma processing apparatus including: a power supply unit for generating pulse power; at least one discharge unit for discharging the pulse power generated in the power supply unit to a water surface including an air layer or to water including air bubbles; and a plasma processing unit for removing underwater microorganisms through plasma generated by the at least one discharge device.

In accordance with another aspect of the present invention, there is provided a ship ballast water processing system including: a filtering device for filtering floating materials and microorganisms from ballast water to be introduced; an underwater pulse plasma processing device for removing microorganisms from the ballast water filtered by the filtering device through plasma generated by discharging pulse power to a water surface including an air layer or to water including air bubbles; an inspecting device for inspecting the ballast water processed by the underwater pulse plasma processing device; and a control device for collecting data transmitted from the filtering device, the underwater pulse plasma processing device, and the inspecting device, and automatically controlling the filtering device, the underwater pulse plasma processing device, and the inspecting device.

In accordance with another aspect of the present invention, there is provided a ship ballast water processing method, including: filtering floating materials and microorganisms from introduced ballast water; removing microorganisms from ballast water filtered by the filtering device through plasma generated by discharging pulse power to a water surface including an air layer or to water including air bubbles; inspecting a sterilization result in said removing the microorganisms from the ballast water; and discharging the sterilized ballast water from the ship if the sterilization result is appropriate and said repetitively removing the microorganisms from the ballast water if the sterilization result is not appropriate.

### ADVANTAGEOUS EFFECTS

In accordance with the present invention, it is possible to remove various microorganisms in ballast water of the ship by performing both a treatment using physical factors (ultraviolet rays, shock waves, heat, and the like) and a treatment using chemical factors (ozone, hydrogen peroxide, OH-activating radicals) with pulse power capable of instantly reaching high power by emitting large energy in a very short time and completely extinct bacteria by destructing cell membranes of the bacteria.

In addition, the present invention has a structure suitable for sterilization of zooplankton, phytoplankton, bacteria, and the like in the ballast water of the ship discharged to the outside (sea) on a large scale.

Since the present invention is connected directly to a discharge port of the ballast water, the present invention is easy to mount and since discharge water is processed by generating underwater pulse plasma during the discharge water flows, the discharge water can be purified by real-time. Therefore, the present invention can be easily installed in newly constructed ships and particularly, old ships.

In the present invention, since an instant pulse is used, power consumption is very low, thereby saving operation cost.

The present invention may be used in a ship ballast water processing system.

### BRIEF DESCRIPTION OF THE DRAWINGS

FIG. 1 is a block diagram of a ship ballast water processing system in accordance with an embodiment of the present invention.

FIG. 2 is a detailed block diagram of an underwater pulse plasma processing apparatus in accordance with the embodiment of the present invention.

FIG. 3 is a detailed block diagram of a power supply unit of FIG. 2 in accordance with the embodiment of the present invention.

FIGS. 4 to 7 are detailed block diagrams of an electrode unit of FIG. 2 in accordance with the embodiment of the present invention.

FIG. 8 is a detailed explanatory diagram of an air injector of the underwater pulse plasma processing apparatus of FIG. 2 in accordance with the embodiment of the present invention.

FIG. 9 is a detailed explanatory diagram of a plasma processing unit of FIG. 2 in accordance with the embodiment of the present invention.

FIG. 10 is a detailed block diagram of an inspector of FIG. 1 in accordance with the embodiment of the present invention.

FIG. 11 is a detailed explanatory diagram of a feeding apparatus moving a filter and a medium in FIG. 10 in accordance with the embodiment of the present invention.

FIG. 12 is a flowchart of an inspection process in the inspector of FIG. 1 in accordance with the embodiment of the present invention.

FIG. 13 is a flowchart of a method of processing ballast water of a ship in accordance with the embodiment of the present invention.

### BEST MODE FOR THE INVENTION

The advantages, features and aspects of the invention will become apparent from the following description of the embodiments with reference to the accompanying drawings, which is set forth hereinafter.

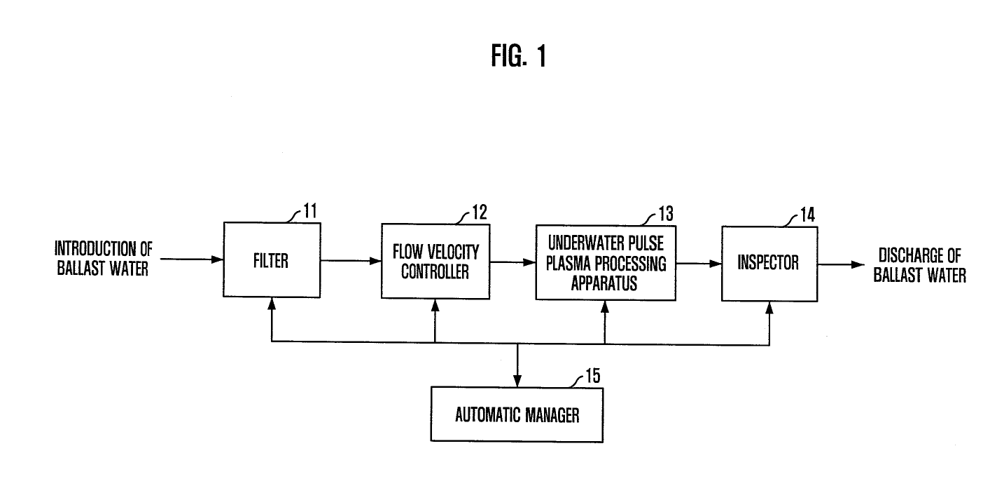

FIG. 1 is a block diagram of a ship ballast water processing system in accordance with an embodiment of the present invention.

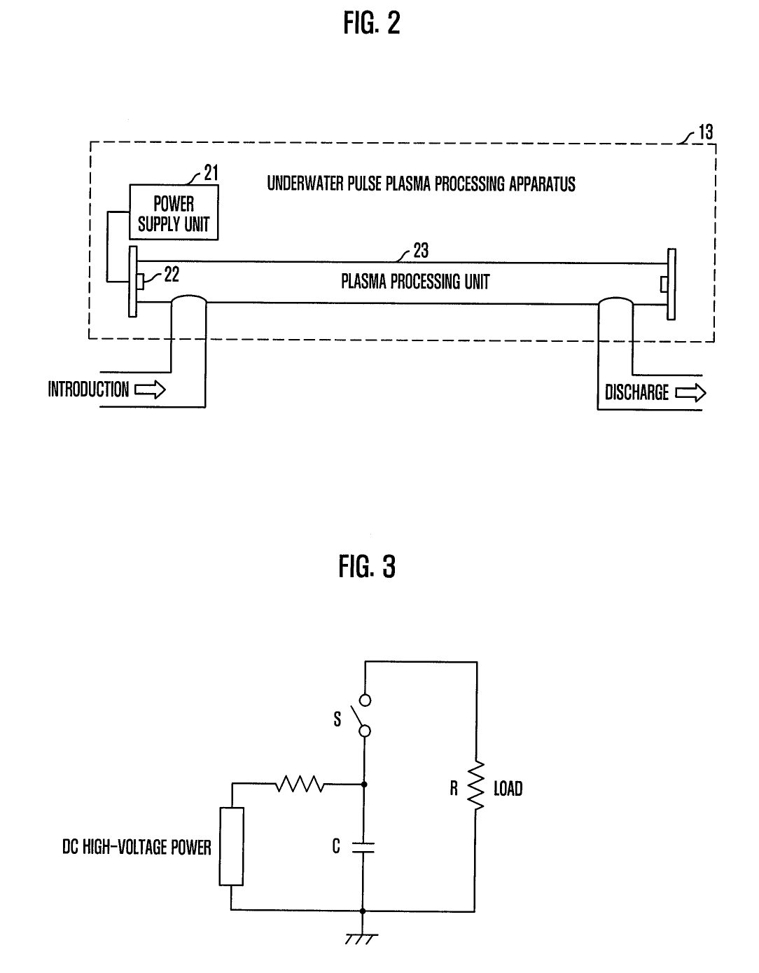

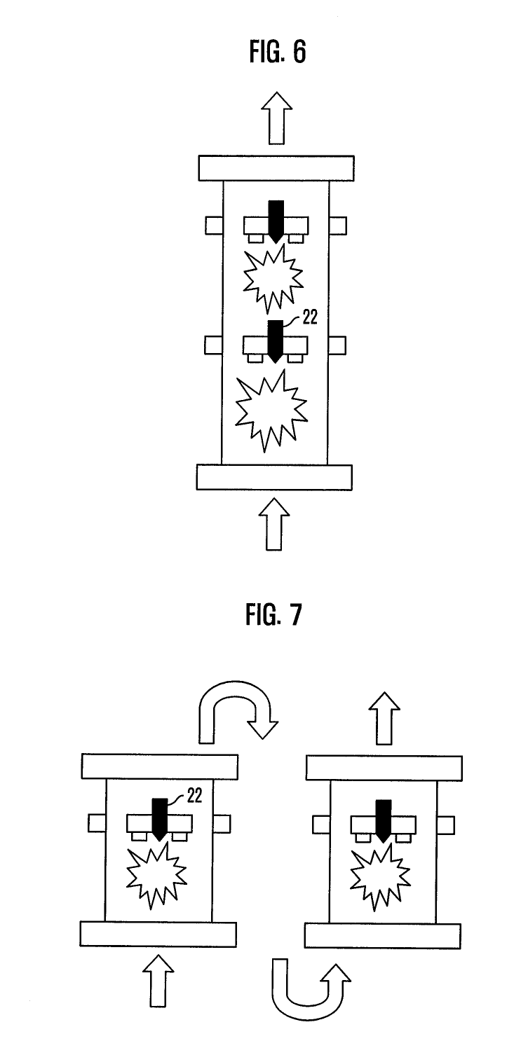

As shown in FIG. 1, a ship ballast water processing system using underwater pulse plasma in accordance with the present invention includes a filter 11 for filtering in ballast water to be introduced, an underwater pulse plasma processing apparatus 13 (see FIG. 2) for removing floating materials and microorganisms from the ballast water filtered by the filter 11 through plasma generated by discharging pulse power to a water surface (see FIG. 4) including an air layer or to an inside of water (see FIGS. 4 to 7) including air bubbles, an inspector 14 for inspecting the ballast water processed by the underwater pulse plasma processing apparatus 13, and an automatic manager 15 for collecting data transmitted from the filter 11, the underwater pulse plasma processing apparatus 13, and the inspector 14, and automatically controlling the data. The ship ballast water processing system using the underwater pulse plasma further includes a flow velocity controller 12 for controlling the flow velocity or/and flow of the ballast water discharged from the filter 11 to allow the ballast water to flow in the underwater pulse plasma processing apparatus 13, under the control of the automatic manager 15.

Herein, the filter 11 serves to firstly filter the floating materials and the microorganisms from the ballast water and filters the floating materials of a predetermined size using a microscreen. Herein, filtering performance can be adjusted according to a design of the microscreen. A washing function is provided so as to prevent the microscreen of the filter 11 from being clogged.

The flow velocity controller 12 allows the ballast water discharged from the filter 11 to constantly flow in the underwater pulse plasma processing apparatus 13. The flow velocity controller 12 regulates the variation in the flow velocity or/and flow of the ballast water caused due to a difference in a size between a pipe which comes out from the filter 11 and a pipe which goes into the underwater pulse plasma processing apparatus 13.

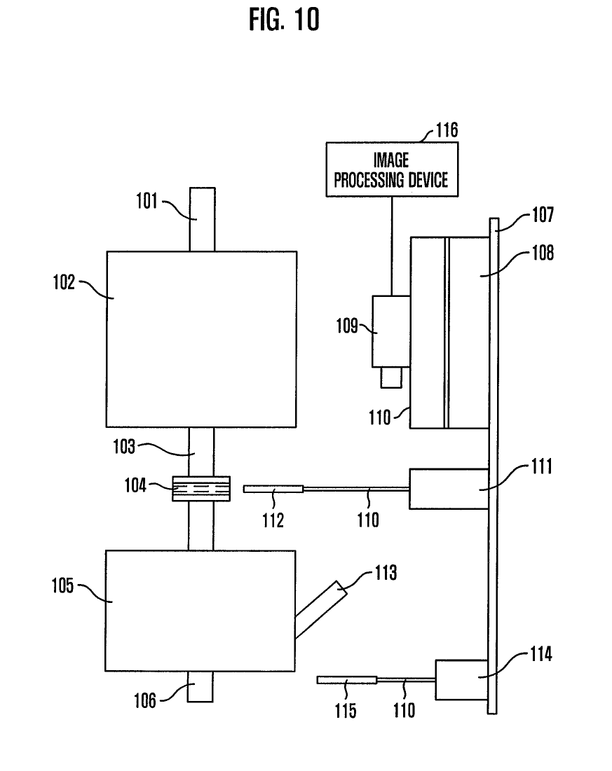

The inspector 14 is used to check a processing level of the ballast water processed in the underwater pulse plasma processing apparatus 13. The inspector 14 measures pH, temperature, salinity, turbidity, dissolved oxygen content, and total floating materials of the processed ballast water with a sensor and inspects cells and sizes of zooplankton and phytoplankton using an image processing method. The inspector 14 will be described in more detail with reference to FIGS. 10 to 12.

However, the inspector 14 inspects the ballast water (plasma sterilized ballast water is referred to as ‘first ballast water’) processed by the underwater pulse plasma processing apparatus 13 for the firstly introduced ballast water and if an inspection result of the first ballast water is appropriate, the inspector 14 skips the inspection of the ballast water (this ballast water is referred to as ‘second ballast water’ to differentiate this water from the first ballast water) processed by the underwater pulse plasma processing apparatus 13 for the ballast water to be introduced thereafter. That is, it is determined that the microorganisms in the ballast water are correctly sterilized. All ballast water to be discharged on a large scale is not inspected. This reason is to rapidly discharge the ballast water.

However, if the inspection result is not appropriate, the inspection result is notified to the automatic manager 15. The remaining microorganisms are sterilized in the underwater pulse plasma processing apparatus 13 under the control of the automatic manager 15. The plasma sterilization process is repetitively performed for the same ballast water. However, when an electrode unit (22 FIG. 2) of the underwater pulse plasma processing apparatus 13 is composed of multi discharge tips (for example, two or more discharge tips as shown in FIGS. 4, 6, and 7 below), one discharge tip is used in first plasma sterilization. After this, if the inspection result is not satisfactory, the plasma sterilization process is performed by increasing the number of the discharge tips (for example, increasing the number of the tips to two from one or when a sterilization effect is remarkably decreased, increasing the number of the tips to three from one). Therefore, a desired sterilization effect can be ultimately obtained. Accordingly, when the desired sterilization effect is obtained for the first ballast water by increasing the number of the discharge tips, the plasma sterilization process is performed by fixing the number of the corresponding discharge tips thereafter. At this time, an additional inspection is not performed for the second ballast water processed by the underwater pulse plasma processing apparatus 13.

In particular, the underwater pulse plasma processing apparatus 13 kills the microorganisms remaining in the ballast water discharged from the filter 11. Particularly, since the sterilization using the underwater pulse plasma can destruct even cell walls of bacteria, it is possible to completely kill poisonous microorganisms. The underwater pulse plasma processing apparatus 13 will be described in more detail with reference to FIGS. 2 to 9.

The automatic manager 15 receives data including voltage, current, flow, operation characteristics, an alarm signal, and the like from the filter 11, the flow velocity controller 12, the underwater pulse plasma processing apparatus 13, and the inspector 14 and monitors the data. The automatic manager 15 performs an automatic control according to a predetermined processing result. The automatic manager 15 serves to store all processed data.

Referring to FIG. 2, the underwater pulse plasma processing apparatus 13 of FIG. 1 will be described in more detail.

As shown in FIG. 2, the underwater pulse plasma processing apparatus 13 includes a power supply unit 21 for generating pulse power, an electrode unit 22 for discharging the pulse power generated in the power supply unit 21 to the water surface (see FIG. 4) including the air layer or to the inside of the water (see FIGS. 4 to 7) including the air bubbles, and a plasma processing unit 23 for removing underwater microorganisms using plasma generated by the electrode unit 22.

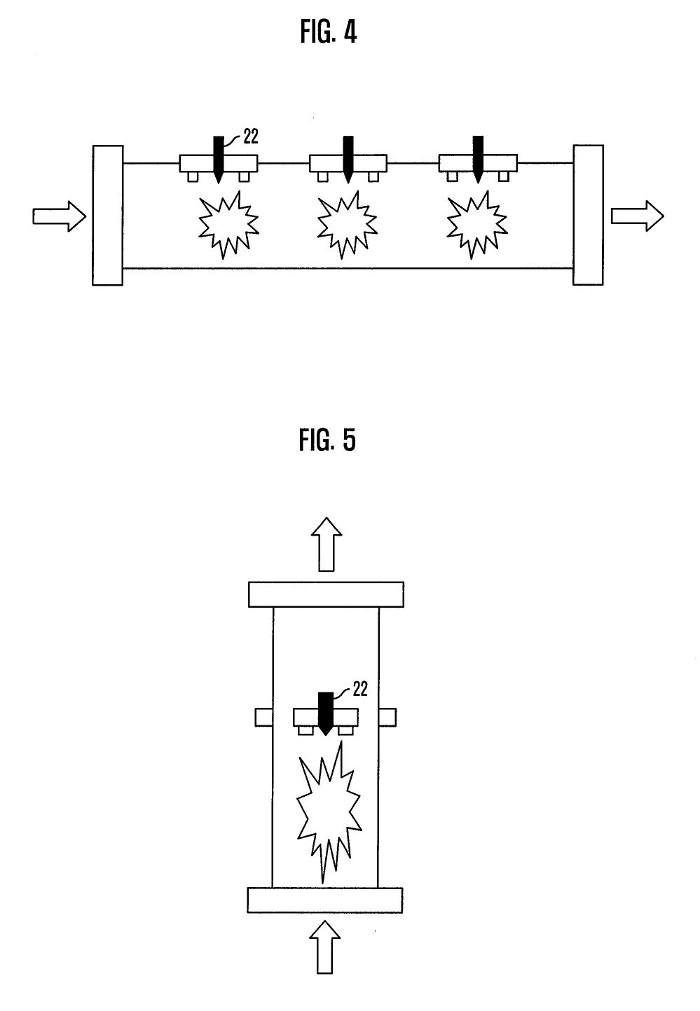

First of all, referring to FIG. 3, the power supply unit 21 will be described in detail as below.

When sea water is introduced into the plasma processing unit 23 through an introduction port, a condenser C is charged with a high voltage in a DC (Direct Current) high voltage power of the power supply unit 21. At this time, when the voltage of the condenser reaches, for example, 7 kV, a switch S (at this time, the switch is an automatic opening and closing switch) is closed. Then, in case that a capacity of a resistor R is small, a large current instantly flows through the resistance and a pulse voltage is thus generated between terminals of the resistance. Therefore, large power (pulse power) is instantly generated. At this time, the generated power is transmitted to the air layer (see FIG. 4) on the water surface or the underwater air bubbles (see FIGS. 4 to 7) through the discharge tips of the electrode unit 22 and the pulse plasma is generated in the sea water. Therefore, shock waves, bubbles, supersonic waves, high-voltage electric fields, and the like are generated, thereby remarkably reducing survival rates of the plankton and the bacteria.

Herein, the pulse voltage shows a higher sterilization effect when a current voltage is high and a capacity of the capacitor is high. However, ultimately, when a pulse generation frequency per unit time increases and an impulse increases, the effective sterilization can be achieved.

The power supply unit 21 of the underwater pulse plasma processing apparatus 13 accumulates electric energy and instantly discharge power. When a condenser having electrostatic capacity of C is charged with a voltage of V by the DC high voltage power, electrostatic energy is shown in Equation 1 below.

W=(½)*(CV²) Equation 1

Accordingly, when the electrostatic energy is accumulated in the condenser and the voltage of the condenser reaches V, a large current instantly flows through the resistance R in case that the capacity of the resistance R is small. Therefore, the pulse voltage is generated between the terminals of the resistor R. Therefore, the large power is instantly generated. The generated power is obtained by timely compression of the charged power.

Huge amount of pulse energy can be obtained at the time of accumulating pulsed power, that is, electric energy and instantly discharging the electric energy. The huge amount of pulse energy is referred to as the pulse power.

Meanwhile, the pulse power depending on the intensity of the current and voltage of the pulse and a pulse width which depends on an ascending time and a descending time of the pulse have a very important influence on the generation of active species, ultraviolet rays, the shock waves, and the like.

Since a waveform of the pulse is determined according to the intensity and waveform of an applied voltage, electrical conductivity of a medium, and the like, an optimal pulse waveform is realized by adjusting the pulse waveform in consideration of the variation of the electrical conductivity of the medium. In case of the pulse power for generating arc plasma having very high instant power by instantly flowing a high current and a high voltage, it is important to increase the repetition rate of short pulses.

It is important to obtain the optimal pulse power intensity and waveform for different plasma loads according to designs of various plasma generators and to increase the repetition rate of high-power pulse power.

Since the underwater pulse plasma processing apparatus 13 uses the pulse power which can instantly reach high power by discharging large energy in a very short time, the underwater pulse plasma processing apparatus 13 can effectively remove various kinds of microorganisms in waste water. In particular, since it is possible to destruct the cell walls of the bacteria with high-power electric pulse at the time of using the underwater pulse plasma, it is possible to deduct higher purification performance. The underwater pulse plasma processing apparatus 13 can perform both a treatment using physical factors (ultraviolet rays, shock waves, heat, and the like) and a treatment using chemical factors (ozone, hydrogen peroxide, OH-activating radicals), which is environmentally influenced a little by the underwater pulse plasma.

Meanwhile, the electrode unit 22 requires counter electrodes of an anode and a cathode so as to generate the plasma. Herein, in general, the anode represents a ground terminal and the cathode represents a power application terminal. Accordingly, in the present invention, the ground terminal (anode) serves as a contact surface of the sea water (the ground terminal is formed on the contact surface of the ballast water introduced into the pipes), whereby all sea water passing pipes has the same structure as a ground surface. Accordingly, firstly, since a surface of the sea water is always close to the ground, a fear of an electric shock by the sea water is solved. Secondarily, the anode can be manufactured in a structure grounding an entire equipment. It is possible to strengthen the plasma sterilization effect by further extending areas to which the discharged energy is applied as the shock waves.

The electrode unit 22 has structures of flat panel-flat panel, probe-flat panel, cylinder-line, pole-pole, and the like. An optimal design variable is deducted by measuring, comparing, and evaluating current-voltage characteristics, the formation of active species, the generation of ultraviolet rays, the intensity of the shock wave, and the like.

The air layer represents an air layer formed between an inside of the pipe and the water surface through the control of the flow velocity or/and flow of the ballast water introduced into the pipe. That is, as shown in FIG. 4, for example, assuming that the pipe has a horizontal structure and the ballast water is introduced to a right side from a left side, the air layer is naturally formed in an upper part inside of the pipe by controlling the flow velocity or/and flow of the ballast water.

Accordingly, as shown in FIG. 4, the electrode unit may have a vertical multi discharge tip structure (assuming a structure of three discharge tips in FIG. 4) vertically spaced in a direction of the introduced ballast water by forming the electrode unit 22 in the upper part inside of the pipe. However, the structure of the electrode unit 22 is not limited to the structure. The electrode unit 22 may have a vertical single discharge tip structure or a vertical multi discharge tip structure.

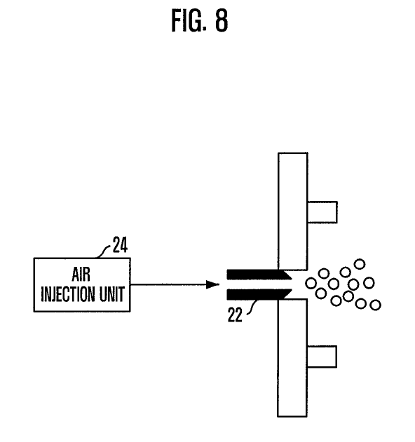

However, even though the pipe has the horizontal structure, the air layer may never be formed in the upper part inside of the pipe according to the control of the flow velocity or/and flow of the ballast water. That is, an inside of the pipe is full of the ballast water. In this case, the air bubbles should be artificially blown into the water through an air injecting portion (24 of FIG. 8) formed for each electrode unit 22. At this time, as shown in FIG. 8, the electrode unit 22 forms an air blowing structure and is formed in a structure of trapping the bubbles generated around the electrode unit 22. The generated bubbles effectively contribute to generating DC arc discharge.

Meanwhile, the air bubbles represent underwater air bubbles injected through the air injection portion (24 of FIG. 8) formed for each corresponding electrode unit 22. That is, as shown in FIGS. 5 and 6, for example, assuming that the pipe has a vertical structure and the ballast water is introduced to an upper direction from a lower direction, the air layer is never formed in the inside of the pipe. That is, the inside of the pipe is full of the ballast water. Accordingly, the air bubbles should be artificially blown into the water through the air injection portion (24 of FIG. 8) formed for each electrode unit 22. At this time, as described above, the electrode unit 22 forms an air blowing structure and is formed in a structure of trapping the bubbles generated around the electrode unit 22. The generated bubbles effectively contribute to generating DC arc discharge.

FIG. 5 shows a horizontal single discharge tip structure in which the electrode unit 22 is formed in a center portion inside of the pipe and is horizontal to a direction of the introduced ballast water. FIG. 6 shows a horizontal multi discharge tip structure in which the electrode unit 22 is formed in the center portion inside of the pipe and is spaced horizontally to the direction of the introduced ballast water.

However, the structure of the electrode unit 22 is not limited to the structure. The electrode unit 22 may have a structure of three or more horizontal multi discharge tips.

The electrode unit 22 may have a multistage horizontal discharge tip structure in which the electrode unit is formed in the center portion inside of the pipe configured in a multistage structure and is horizontal to the direction of the ballast water to be introduced by bending the pipe for controlling the flow velocity. The reason of bending the pipe is to enhance the plasma sterilization effect by adjusting the flow velocity of the ballast water by naturally controlling the flow velocity.

However, the pipe having a vertical structure is assumed in FIGS. 5 to 7, but even though the pipe has a horizontal structure, the air layer may be never formed inside of the pipe according to a result of the control of the flow velocity or/and flow of the ballast water. Even in this case, the air bubbles should be artificially blown into the water through the air injection portion (24 of FIG. 8) formed for each electrode unit 22.

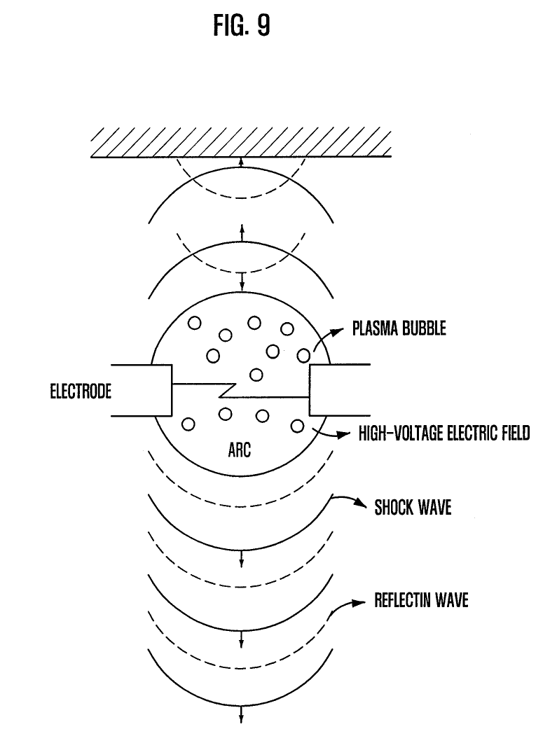

Referring to FIG. 9, a plasma generation process in a plasma processing apparatus 23 will be described in more detail.

Corona discharge or arc discharge driven by the pulse is used as plasma which can be generated in the water.

Thermal plasma used in a plasma process is generated mainly by DC arc discharge or high-frequency inductive coupling discharge.

Pulse power which can easily instantly output high power is used to induce the generation of arc plasma. Since this pulse power emits large energy in a very short time, the high power can be instantly reached, thereby effectively killing various kinds of microorganisms in the waste water.

Destruction of cells using the shock waves, destruction of the cells using supersonic waves, destruction of the cells using the high-voltage electric fields, and the like can be achieved by the plasma processing. Hereinafter, this will be described in more detail.

First, in the destruction of the cells using the shock waves, the cells can be destructed using the shock waves generated by pressure fluctuations. At this time, the destruction of the cells depends on sizes, forms, thicknesses, and the like of the cells, and the intensity of the shock waves by the arc discharge.

In the destruction of the cells using the supersonic waves, the supersonic waves may cause cavitation with passing through a liquid. The cavitation is the phenomenon a bubble is formed and blasted when a part having low liquid density is lower than a vapor pressure when a part having low liquid density and a part having high liquid density are formed by making longitudinal waves with a supersonic oscillator when the supersonic waves passes through a liquid medium by the supersonic oscillator. The cells are destructed using the shock waves generated by this blasting. The destruction of the cells using the supersonic waves is a method used to destruct cells of a small quantity of microorganisms.

In the destruction of the cells using the high-voltage electric fields, insulating bodies referred to as cell membranes are destructed by inducing high potential to the cell membranes.

Accordingly, it is possible to remarkably reduce survival rates of the plankton and bacteria by operations of the ultraviolet rays, active species, shock waves, bubbles, and the like generated by the plasma processing.

When a discharge device of a plasma sterilization apparatus is a height of 50 mm, a discharge voltage of 7 kV, and a capacitor of 6 uF, a lethal rate is 100% after a processing time of 60 seconds. A lethal efficiency measurement result of the zooplankton is shown in Table 1.

TABLE 1

| | No. of | No. of dead | Total No. of |
|---|---|---|---|
| | survived cells | cells | cells |
| | (inds./1 l) | (inds./1 l) | (inds./1 l) |
| No. of samples | 22,900 | 100 | 23,000 |
| No. of processed | 0 | 1,387 | 1,387 |
| samples | | | |

| | |
|---|---|
| Processing | 100.0 |
| efficiency (%) | |
| Destruction rate | 94.1 |
| (%) | |

According to a result of measurement of the number of samples before testing the plasma sterilization apparatus, general bacteria form TNTC (Too Numerous To Count). A colon bacillus is 100 cfu/100 ml and coliform bacteria are 310 cfu/100 ml. However, according to a result of observing the number of samples by culturing the samples for 48 hours after testing the plasma sterilization apparatus, the general bacteria is 0 cfu/100 ml, the colon bacillus is 0 cfu/100 ml, and the coliform bacteria are 0 cfu/100 ml. Therefore, it is measured that all the cultured bacteria are sterilized. It is determined that the processing efficiency of the sterilization apparatus is high.

Hereinafter, referring to FIGS. 10 to 12, the configuration and operation process of the inspector 14 of FIG. 1 will be described in more detail.

The inspector 14 serves to check the purification performance of discharged water in real time.

Referring to FIG. 10, the inspector 14 includes a first storage tank 102 for storing the ballast water supplied through an input pipe 101 by operation of a motor pump in the ship, a filter 112 for filtering the zooplankton and the phytoplankton in the first storage tank 102, which is supplied through an intermediate pipe 103, a filter case 104 for connecting the filter 112, a first feeding cylinder 111 for mounting the filter 112 on the filter case 104 by moving the filter 112 to the filter case 104, a second storage tank 105 for storing the ballast water passing the filter 112, a sampling device 113 for sampling a sample of 1 ml from the ballast water stored in the second storage tank 105, a medium 115 for receiving the sample picked in the sampling device 113, a second feeding cylinder 114 for moving the medium 115, a camera 109 for photographing the zooplankton and the phytoplankton on the filter 112 and the medium 115, a feeding slider 108 for moving the camera 109, a limit switch 110 for controlling positions of the first feeding cylinder 111, the second feeding cylinder 114, and the feeding slider 108, and a support 107 for attaching the first feeding cylinder 111, the second feeding cylinder 114, and the feeding slider 108. The inspector 104 further includes an image processing apparatus 116 for analyzing the number of cells and sizes of the zooplankton and the phytoplankton through the image processing from the image photographed by the camera 109.

In order to automatically inspect the zooplankton and the phytoplankton in the ballast water with the camera 109, the zooplankton and the phytoplankton are filtered by the filter 112 according to the potential energy of the first storage tank 102 and the second storage tank 105 and the sample of 1 ml is dropped on the medium 115 from the sampling device 113 attached to the second storage tank 105.

As a device for automatically inspecting the zooplankton and the phytoplankton in the ballast water, the filter 112, the medium 115, and the camera 109 are attached to the first feeding cylinder 111, the second feeding cylinder 114, and the feeding slider 108 so as to collect and the inspect the zooplankton and the phytoplankton. The limit switches 110 attached to the first feeding cylinder 111, the second feeding cylinder 114, and the feeding slider 108 are used for proper positioning at the time of photographing the zooplankton and the phytoplankton using the camera 109.

Joining the filter 112 to the filter case 104 at the time of discharging the ballast water in the first storage tank 102 is achieved by attaching the filter 112 to grooves of the filter case 104 with the first feeding cylinder 111 by forming the grooves in the inside of the filter case 104 to suit to an exterior size of the filter 112.

The operation of the inspector 14 will be hereinafter described in more detail.

First, the ballast water is stored in the first storage tank 102 through the input pipe 101 and when the filter 112 is joined to the filter case 104 attached to between the first storage tank 102 and the second storage tank 105 by the first feeding cylinder 111 of the support 107, the ballast water in the first storage tank 102 positioned above the filter 112 is filtered by the filter 112. The number of the zooplankton in the filtered ballast water is measured by moving the camera 109 to the filter 112 by operating the feeding slider 108 of the support 107.

The ballast water passing the filter 112 of the filter case 104 is stored in the second storage tank 105. The ballast water of 1 ml is dropped on the medium 115 connected to the second feeding cylinder 114 of the support 107 by the sampling device 113.

When the number of the phytoplankton is measured by moving the camera 109 to the medium 115 by the feeding slider 108 of the support 107, the ballast water is discharged by a discharge pipe 106.

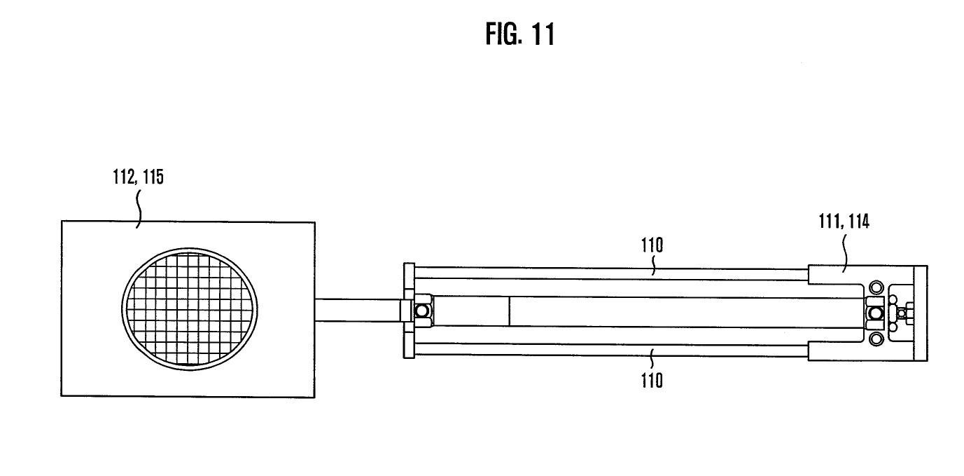

As shown in FIG. 11, feeding devices for moving the filter 112 and the medium 115 is configured by joining the filter 112 and the medium 115 by the first feeding cylinder 111 and the second feeding cylinder 114. The positioning of the filter 112 and the medium 115 is performed by the limit switches 110 attached to the first feeding cylinder 111 and the second feeding cylinder 114.

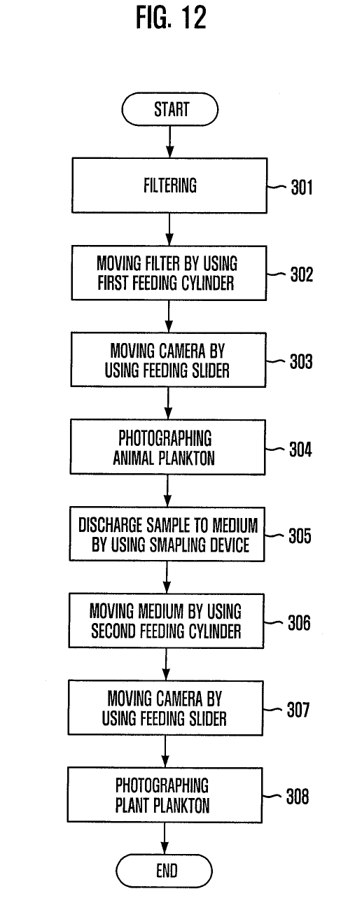

Hereinafter, referring to FIG. 12, an inspection process performed in the inspector 14 will be described.

As shown in FIG. 12, in the inspection process, the filtering is performed by the filter 112 (301), the filter 112 is moved to a predetermined position by the first feeding cylinder 111 (302), and the zooplankton is photographed (304) while the camera 109 is moved onto the filter 112 by the feeding slider 108 (303). After this, the medium 115 is moved to a predetermined position (306) by the second feeding cylinder 114 so that the sample is discharged by the sampling device 113 (305) and the phytoplankton is photographed (308) while the camera 109 is moved onto the medium 115 by the feeding slider 108 (307).

In order to help understanding, the image processing process performed in the image processing apparatus 116 will be described.

In particular, whether or not the zooplankton and the phytoplankton serving as a processing standard of the ballast water become extinct can be verified by using the image processing. The sizes and the number of cells of the zooplankton and the phytoplankton are obtained by the image processing in the image processing apparatus 116 by photographing the samples laid on the filter 112 and the medium 115 with the camera 109.

The image processing apparatus 116 analyzes whether or not the number of cells, the sizes and the life or death of the microorganism of the zooplankton and the phytoplankton by obtaining the processed image from the image photographed by the camera 109. The image processing process includes filtering, edge detection, bloc analysis, a histogram intensity method, a thresholding method, size filtering, image segmentation, object extraction, object measurement, pattern matching, pattern recognition, and data extraction.

First of all, samples to be measured are collected and obtained.

The collected and obtained samples are photographed by the camera 109 to obtain images of the samples.

Subsequently, the filtering is performed so as to remove noise from the obtained image and the image edge detection is performed so as to obtain information including a position, a shape, a size, a surface pattern, and the like. After the edge detection, the sizes of the microorganisms are obtained through the blob analysis.

Next, the histogram intensity method is applied so as to satisfy a function of a pattern by determining the distribution of contrast values of pixels belonging to an object and a background part and a threshold is determined.

Then, the size filtering is performed so as to remove a pixel generated due to a noise and the image segmentation is performed so as to separating the object and the background from the obtained image.

Subsequently, the object extraction process is performed so as to extract only the object from the object and the background which are separated in the process of the image segmentation, and characteristics including a size, a position, a direction, and the like of the extracted object are measured.

Next, the pattern matching is performed so as to bring basic judgment through a matching work between the extracted object and data on the zooplankton and the phytoplankton stored in a database. Then, the data extracting process of extracting necessary data based on the processed image is performed after the pattern recognition is performed for correct discrimination.

First, the collection of the samples is described as below.

After determining whether to measure the zooplankton or to measure the phytoplankton, samples discharged from the first storage tank 102 are collected through the filter 112 in case of measuring the zooplankton and samples discharged from the second storage tank 105 are obtained by being received with the medium 115 in case of measuring the phytoplankton.

Meanwhile, magnification control and auto focusing functions of the camera 109 are performed in the course of photographing the samples collected or obtained with the camera 109. Since a variation of a focus value by the movement of a zoom lens and a focus lens is not linear, the magnification control function of the camera 109 has many difficulties in realizing an algorithm. Zoom tracking serves to prevent a focus of the camera 109 from being beside the point with moving a zoom motor and a focus motor on a zoom curve. Herein, the zoom curve is data for defining a position of the focus lens which can show a clearest image in each magnification with increasing the magnification of the zoom lens in a state that a distance between a subject and the camera 109 is fixed.

Accordingly, the clearest image is obtained by using a method of reducing a storage capacity of the zoom tracking curve by dividing the zoom tracking curve into a linear section and a nonlinear section and a method of calculating the zoom tracking curve best reflecting a focus distance from the current subject during the zoom tracking so as to prevent the focus from being beside the point during the zoom function is activated.

The image acquisition and the image filtering are described as below.

In the image acquisition, image data which can be used for the image processing is produced by using the camera 109. At this time, the image data is stored in a bitmap form and a digital form.

The image acquired in a physical device may be just used, but in general, a filtering process for making the image more useful for recognition by removing the noise by using various filters and the histogram intensity method is added.

The edge detection is described as below.

In the general image processing, an edge is a characteristic representing a boundary of an area in the image and represents discontinuity of pixel brightness. The edge corresponds to an edge of the object in the image and provides the position, shape, size, a surface pattern, and the like of the object.

In the edge detection method, the edge is detected based on the partial differential operator calculation of the image. In the edge detection method, there are various masks serving as differential operators. These masks satisfy a mathematical condition and have the same effect. Herein, the masks are structures having a matrix shape for positioning at predetermined parts. Square matrices of a 3 to 3 matrix, a 5 to 5 matrix, a 16 to 16 matrix, and the like are mainly used. Sobel mask Prewitt mask, Robert mask, Laplacian mask, Canny edge detection methods are used as the representative edge detection method.

The Blob analysis is an analysis technique the number of objects in a predetermined area can be obtained by counting the number of desired objects and statistics values such as lengths of the objects, sizes of the areas, an average, and distribution can be automatically obtained. Therefore, it is possible to verify the sizes of the microorganisms by this method.

The thresholding method is one of techniques for extracting characteristics of image data acquired through the edge detection. The thresholding method handles the data by dividing the data into black data and white data by using a gray image of binary data as the threshold. In threshold processing, a pixel value of an output image corresponding to each pixel of an input image having brightness of a predetermined value or more is fixed to 1 and pixel values of the other output images are fixed to 0.

The histogram intensity method is an important method used to recognize the object in a preprocessing process of the image processing. Since the pixels of the object in the image have similar distribution, it is possible to determine the distribution of brightness values of the pixels belonging to the object part and the background part by analyzing a top and a bottom of a histogram. In case of creating the masks using a binary block technique, since extracted patterns are scattered and the number of the extracted patterns is small, the patterns may not correctly perform a pattern. In order to overcome this problem, the histogram intensity method is used.

In the size filtering, a binary image may have a noise due to the resolution of the camera 109 or the nonuniformity of illumination and since this noise is irregularly generated, the number of pixels of connection components corresponding to the noise is small. Accordingly, the size filtering removes connection components having less than a predetermined number of pixels among the connection components on the image and is a simple and effective method for removing pixels generated by the noise.

The image segmentation is a process of separating the object and the background.

In the extraction and measurement of the object, only the object is extracted from the separated object and background.

Characteristics including a size, a position, a direction, and the like of an extracted object are calculated by labeling. Herein, the labeling is the processing of attaching the same label (an integer value) to connection components of the same kind and attaching different labels to different connection components. Each of connection components acquired from a labeled image may display any object and the characteristics including the size, position, direction, and the like of each connection component is determined.

Meanwhile, an algorithm in which all the connection components are found in the image and one unique label is attached to all the pixels existing in the same connection component is a component labeling algorithm. The component labeling algorithm includes a recursive algorithm and a sequential algorithm. Herein, in the recursive algorithm, since the calculation takes a long time in a serial computer, the recursive algorithm is generally used in a parallel computer. The sequential algorithm takes a calculation time shorter than the recursive algorithm. The sequential algorithm consumes memories less than the recursive algorithm. In addition, the sequential algorithm can finish the calculation only by twice full scanning operations.

The pattern matching is a process of comparing the data stored in the database with the extracted object. The basic information of the object is determined through the matching work between the data on the zooplankton and the phytoplankton, which are stored in the database, and the extracted object.

Since a possibility of acquiring results such as the correct discrimination of species, the determination of the number of cells, and the determination of life and death is decreased even though the image is processed by binary processing or a histogram equalizing technique. The pattern recognition is used as a method for overcoming this problem. At this time, a recognition rate in the pattern recognition can be enhanced by applying a neural network algorithm.

The neural algorithm is based on a point that a human brain having a study function is composed of a neural network in which a plurality of neurons are connected to each other. The neural network is composed of units acquired by modeling biological neurons and weighted connections between the units. The neural network has various structures and their own study rules by each neural network model.

Each NN (Neural Network) is formed of a set of neurons grouped for each layer. The neural network is composed of three layers such as an input layer, a hidden layer, and an output layer. Various layers may exist between the input layer and the output layer. As a synapse plays an important role in information delivery between the biological neurons, a connection weighted value is used in the neural network so as to reflect a weight between processing components. Each of the processing components calculates an input value with a delivered input value and the connection weight value, and then, determines an output value by using the input value.

The neural network has following advantages.

Fault Tolerance: Since the number of processing nodes is large, faults of a few nodes or a few connections does not bring about an entire system fault.

Generalization: When an incomplete or previously unknown input is displayed, the neural network may create a reasonable reaction.

Adaptability: The neural network studies under a new environment and instantly uses a new case to update and maintain a program.

The above-mentioned characteristics and advantages are used to enhance the recognition rate in the pattern recognition.

In the data extraction, necessary data (size, number, etc.) are extracted based on the previously processed and are stored in the database.

Optimal images of the zooplankton and the phytoplankton are acquired through the process and the numbers of cells of the zooplankton and the phytoplankton are verified through the acquired images.

Meanwhile, in case of verifying the life or death of the microorganisms, the life or death of the zooplankton is verified through the motion change of the microorganisms by reperforming the process after a predetermined time is elapsed and the life or death of the phytoplankton is verified according to dyeing or not by using a dye solution.

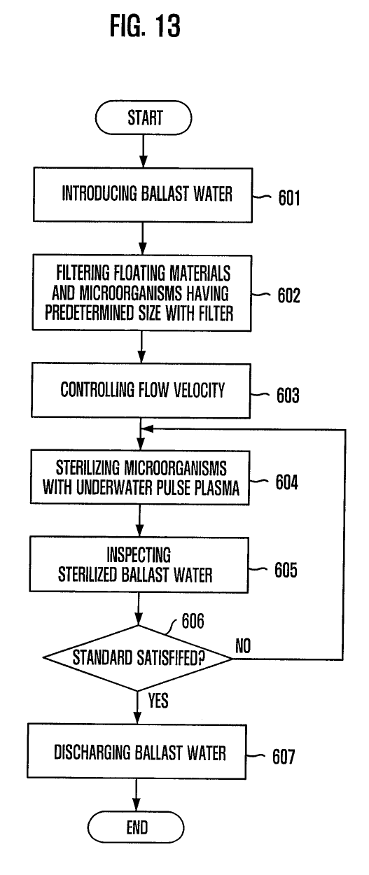

Lastly, referring to FIG. 13, a method of processing the ballast water of the ship using the underwater pulse plasma in accordance with the present invention will be hereinafter described.

As shown in FIG. 13, in the method of processing the ballast water of the ship using the underwater pulse plasma in accordance with the present invention, the ballast water is introduced (601) and the floating materials and microorganisms having the predetermined size are filtered by using the filter 11 (602).

After the flow velocity of the filtered ballast water is controlled to allow the filter ballast water to flow in a fixed flow by the flow velocity controller 12 (603), remaining microorganisms are sterilized through the underwater pulse plasma processing apparatus 13 (604).

After the sterilization, the sterilized ballast water is inspected through the inspector 14 (605) and it is judged that the ballast water satisfies a predetermined standard (606).

According to a judgment result, if the ballast water satisfies the predetermined standard, the ballast water is discharged from the ship (607) and if the ballast water does not satisfy the predetermined standard, the sterilization of the microorganisms using the underwater pulse plasma processing apparatus 13 is reperformed (604).

That is, the inspector 14 inspects the first ballast water acquired by processing firstly introduced water with the underwater pulse plasma processing apparatus 13 and if an inspection result satisfies the standard, the inspector skips the inspection of the second ballast water acquired by processing the ballast water to be introduced thereafter with the underwater pulse plasma processing apparatus 13.

However, if the inspection result does not satisfy the standard, the microorganisms remaining in the first ballast water is again sterilized in the underwater pulse plasma processing apparatus 13. At this time, in a case that the electrode unit 22 of the underwater pulse plasma processing apparatus 13 is composed of the multi discharge tips (for example, the structure of two or more discharge tips as shown in FIGS. 4, 6, and 7), a ultimately desired plasma sterilization effect may be acquired by performing the plasma sterilization process through increasing the number of the discharge tips. As described above, when the desired plasma sterilization effect is acquired by increasing the number of the discharge tips, the additional inspection of the second ballast water (assuming the first ballast water in which the desired plasma sterilization effect is acquired by increasing the number of the discharge tips) is not performed.

Meanwhile, the above-mentioned method in accordance with the present invention can be prepared by a computer program. Codes and code segments which configure the program can be easily deduced by a computer programmer skilled in the related art. The prepared program is stored in a computer-readable recording medium (information storage medium), and is read and executed by the computer. Therefore, the method in accordance with the present invention is realized. The recording medium includes computer-readable recording media of all forms.

While the present invention has been described with respect to the specific embodiments, it will be apparent to those skilled in the art that various changes and modifications may be made without departing from the spirit and scope of the invention as defined in the following claims.

What is claimed is:

1. An underwater pulse plasma processing apparatus comprising:
a power supply unit for generating pulse power;
at least one discharge unit for discharging the pulse power generated in the power supply unit to a water surface including an air layer or to water including air bubbles; and
a plasma processing unit for removing underwater microorganisms through plasma generated by the at least one discharge device.

2. The underwater pulse plasma processing apparatus of claim 1, wherein the air layer is an air layer formed between an inside of a pipe and the water surface through the control of a flow velocity or/and flow of water introduced into the pipe.

3. The underwater pulse plasma processing apparatus of claim 2, wherein the at least one discharge unit has a vertical single discharge tip structure in which the discharge unit is formed in an upper part inside of the pipe and is vertical to a direction of the introduced water.

4. The underwater pulse plasma processing apparatus of claim 2, wherein the at least one discharge unit has a vertical multi discharge tip structure in which the discharge unit is formed in the upper part inside of the pipe and is spaced vertically to the direction of the introduced water.

5. The underwater pulse plasma processing apparatus of claim 1, wherein the air bubbles are underwater air bubbles injected through an air injection unit formed for each corresponding discharge unit.

6. The underwater pulse plasma processing apparatus of claim 5, wherein the at least one discharge unit has a structure in which air is blown through a hole formed in a center thereof.

7. The underwater pulse plasma processing apparatus of claim 6, wherein the at least one discharge unit has a horizontal single discharge tip structure in which the discharge unit is formed in a center portion inside of a pipe and is horizontal to the direction of water to be introduced.

8. The underwater pulse plasma processing apparatus of claim 6, wherein the at least one discharge unit has a horizontal multi discharge tip structure in which the discharge unit is formed in a center portion inside of a pipe and is spaced horizontally to the direction of water to be introduced.

9. The underwater pulse plasma processing apparatus of claim 6, wherein the at least one discharge unit has a multistage horizontal discharge tip structure in which the discharge unit is formed in a center portion inside of a pipe configured in a multistage structure and is horizontal to the direction of water to be introduced by bending the pipe for controlling the flow velocity.

10. The underwater pulse plasma processing apparatus of claim 6, wherein the at least one discharge unit has a vertical multi discharge tip structure in which the discharge unit is formed in an upper part inside of a pipe and is spaced vertically to the direction of water to be introduced.

11. The underwater pulse plasma processing apparatus of claim 3, wherein the at least one discharge unit serves as a power application terminal (cathode) and a ground terminal (anode) serving as a counter electrode is formed on a contact surface of the water introduced into the pipe.

12. The underwater pulse plasma processing apparatus of claim 1, wherein the power supply unit generates the pulse power by charging and discharging DC high-voltage power through automatically opening and closing a switch.

13. A ship ballast water processing system comprising:
a filtering device for filtering floating materials and microorganisms from ballast water to be introduced;
an underwater pulse plasma processing device for removing microorganisms from the ballast water filtered by the filtering device through plasma generated by discharging pulse power to a water surface including an air layer or to water including air bubbles;
an inspecting device for inspecting the ballast water processed by the underwater pulse plasma processing device; and
a control device for collecting data transmitted from the filtering device, the underwater pulse plasma processing device, and the inspecting device, and automatically controlling the filtering device, the underwater pulse plasma processing device, and the inspecting device.

14. The ship ballast water processing system of claim 13, wherein if an inspection result is appropriate, the inspecting device skips the inspection of the ballast water processed by the underwater pulse plasma processing device for the ballast water to be introduced thereafter.

15. The ship ballast water processing system of claim 13, wherein if the inspection result is not appropriate, the inspecting device allows the remaining microorganisms to be sterilized in the underwater pulse plasma processing device under the control of the control device by notifying an inspection result to the control device.

16. The ship ballast water processing system of claim 13, wherein if the inspection result is not appropriate, the inspecting device allows at least two discharge tips to be driven in the underwater pulse plasma processing device under the control of the control device by notifying an inspection result to the control device.

17. The ship ballast water processing system of claim 13, further comprising:
a flow velocity control device that controls the flow velocity or/and flow of the ballast water discharged from the filtering device to allow the ballast water to be introduced into the underwater pulse plasma processing device under the control of the control device.

18. The ship ballast water processing system of claim 13, wherein the filtering device serves to firstly filter the floating materials and the microorganisms from the ballast water and filters the floating materials of a predetermined size using a microscreen, filtering performance can be adjusted according to a design of the microscreen, and a washing function is provided so as to prevent the microscreen of the filtering device from being clogged.

19. The ship ballast water processing system of claim 13, wherein the underwater pulse plasma processing device includes:
a power supply unit for generating the pulse power;
at least one discharge unit for discharging the pulse power generated in the power supply unit to the water surface including the air layer or to the water including the air bubbles; and
a plasma processing unit for removing underwater microorganisms through plasma generated by the at least one discharge device.

20. The ship ballast water processing system of claim 19, wherein the air layer is an air layer formed between an inside of a pipe and the water surface through the control of the flow velocity or/and flow of the water introduced into the pipe.

21. The underwater pulse plasma processing system of claim 20, wherein the at least one discharge unit has a vertical single discharge tip structure in which the discharge unit is formed in an upper part inside of the pipe and is vertical to a direction of the introduced water.

22. The underwater pulse plasma processing system of claim 20, wherein the at least one discharge unit has a vertical multi discharge tip structure in which the discharge unit is formed in the upper part inside of the pipe and is spaced vertically to the direction of the introduced water.

23. The underwater pulse plasma processing system of claim 19, wherein the air bubbles are underwater air bubbles injected through an air injection unit formed for each corresponding discharge unit.

24. The underwater pulse plasma processing system of claim 23, wherein the at least one discharge unit has an air blowing structure in which air is blown through a hole formed in a center thereof.

25. The underwater pulse plasma processing system of claim 24, wherein the at least one discharge unit has a horizontal single discharge tip structure in which the discharge unit is formed in a center portion inside of the pipe and is horizontal to the direction of the introduced water.

26. The underwater pulse plasma processing system of claim 24, wherein the at least one discharge unit has a horizontal multi discharge tip structure in which the discharge unit is formed in the center portion inside of the pipe and is spaced horizontally to the direction of the introduced water.

27. The underwater pulse plasma processing system of claim 24, wherein the at least one discharge unit has a multistage horizontal discharge tip structure in which the discharge unit is formed in the center portion inside of the pipe configured in a multistage structure and is horizontal to the direction of the water to be introduced by bending the pipe for controlling the flow velocity.

28. The underwater pulse plasma processing apparatus of claim 24, wherein the at least one discharge unit has a vertical multi discharge tip structure in which the discharge unit is formed in an upper part inside of the pipe and is spaced vertically to the direction of the introduced water.

29. The ship ballast water processing system of claim 19, wherein the inspecting device includes:
a first storage unit for storing the ballast water supplied through an input pipe by operation of a motor pump in the ship;
a filtering unit for filtering an analyte in the first storage unit;
a filter joining unit for joining the filtering unit
a first feeding cylinder for mounting the filtering unit on the filter joining unit by moving the filtering unit to the filter joining unit;
a second storage unit for storing the ballast water passing the filtering unit;
a sampling unit for sampling a sample of a predetermined amount from the ballast water stored in the second storage unit;
a sample collecting unit for receiving the sample picked in the sampling unit;
a second feeding cylinder for moving the sample collecting unit;
a photographing unit for photographing the analyte filtered in the filtering unit and collected in the sample collecting unit;
a feeding slider for moving the photographing unit;
a switching unit for controlling positions of the first feeding cylinder, the second feeding cylinder, and the feeding slider; and
a supporting unit for attaching the first feeding cylinder, the second feeding cylinder, and the feeding slider.

30. The ship ballast water processing system of claim 29, further comprising: an image processing device for analyzing the number of cells and sizes of zooplankton and phytoplankton through image processing from an image photographed by the photographing unit.

31. A ship ballast water processing method, comprising:
filtering floating materials and microorganisms from introduced ballast water;
removing microorganisms from ballast water filtered by the filtering device through plasma generated by discharging pulse power to a water surface including an air layer or to water including air bubbles;
inspecting a sterilization result in said removing the microorganisms from the ballast water; and
discharging the sterilized ballast water from the ship if the sterilization result is appropriate and said repetitively removing the microorganisms from the ballast water if the sterilization result is not appropriate.

32. The ship ballast water processing method of claim 31, wherein in said repetitively removing the microorganisms from the ballast water, the microorganisms are sterilized by increasing the number of discharge tips.

33. The ship ballast water processing method of claim 31, wherein in said repetitively removing the microorganisms from the ballast water, the microorganisms are sterilized by driving multi discharge tips spaced at a predetermined interval.

34. The ship ballast water processing method of claim 31, wherein, in said repetitively removing the microorganisms from the ballast water, if the sterilization result is appropriate, the sterilized ballast water is discharged from the ship without inspecting the sterilized ballast water for the following introduced ballast water.
